(19) United States
(12) Patent Application Publication
(10) Pub. No.: US 2011/0281572 A1
(43) Pub. Date: Nov. 17, 2011

(54) APPARATUS AND METHOD FOR COMMUNICATION OF MULTIPLE-STANDBY MOBILE TERMINAL

(75) Inventors: Jae Rok CHO, Seoul (KR); Jeong Seok LEE, Seoul (KR); Jong Doo KIM, Jeonju-si (KR)

(73) Assignee: SAMSUNG ELECTRONICS CO. LTD., Suwon-si (KR)

(21) Appl. No.: 13/036,242

(22) Filed: Feb. 28, 2011

(30) Foreign Application Priority Data
May 17, 2010 (KR) 10-2010-0045813

(51) Int. Cl. H04W 4/00

(52) U.S. Cl. 455/418

(57) ABSTRACT

An apparatus and method for a communication by a multiple-standby mobile terminal is provided. The apparatus includes a master communication module that directly receives a signal from a communication network and then processes it, or processes a signal to be transmitted and then directly transmits it to the communication network. Additionally, the master communication module indirectly receives a signal from the communication network through a slave communication module and then processes it, or processes a signal to be transmitted and then indirectly transmits it to the communication network through the slave communication module. Therefore, even though the slave communication module has only elements for transmitting and receiving a signal with the other elements eliminated, the multiple-standby mobile terminal may operate favorably.

### PRIORITY

This application claims the benefit under 35 U.S.C. §119(a) of a Korean patent application filed on May 17, 2010 in the Korean Intellectual Property Office and assigned Serial No. 10-2010-0045813, the entire disclosure of which is hereby incorporated by reference.

### BACKGROUND OF THE INVENTION

1. Field of the Invention

The present invention relates in general to a mobile communication terminal. More particularly, the present invention relates to an apparatus and method for communication by a multiple-standby mobile terminal.

2. Description of the Related Art

Normally, a mobile communication terminal performs a variety of functions offered inherently or optionally. Nowadays, multiple-mode mobile terminals that support at least two wireless communication networks have been introduced. The multiple-mode mobile terminal accesses one of the networks, depending on a user's selection, and then performs communication with the selected network. However, this type of mobile terminal may have some difficulty in switching between the networks to be used.

Therefore, a multiple-standby mobile terminal that allows for simultaneous access to at least two wireless communication networks has been proposed. This type of mobile terminal may check channel conditions by receiving a preamble or pilot signals from base stations in the respective networks. This requires the mobile terminal to involve different communication modules to be used for respective accesses to the networks. In addition, each module should individually process a signal received from or to be transmitted to its corresponding network.

Since such communication modules generally have the same configuration, some elements of the multiple-standby mobile terminal may be duplicated. Thus, when the communication modules operate, the multiple-standby mobile terminal may not always need some elements thereof. Additionally, the multiple-standby mobile terminal should have a switching member for selectively using the communication modules. For instance, when a signal to be transmitted is input, the mobile terminal wirelessly transmits the signal through one of the communication modules. At this time, the mobile terminal selects one of the communication modules through the switching member and offers the signal to the selected module.

### SUMMARY OF THE INVENTION

Aspects of the present invention are to address at least the above-mentioned problems and/or disadvantages and to provide at least the advantages described below. Accordingly, an aspect of the present invention is to provide a multiple-standby mobile terminal that is allowed to operate even though some elements of communication modules are eliminated.

Another aspect of the present invention is to provide a multiple-standby mobile terminal that is allowed to operate without requiring a typical switching member.

In accordance with an aspect of the present invention, a method for a communication of a multiple-standby mobile terminal is provided. The method includes determining, by a master communication module, a communication mode. If the communication mode is for a slave communication module, the master communication module transfers a signal to be transmitted to the slave communication module. Then the slave communication module transmits the signal wirelessly.

In this method, when a wireless signal is received, the slave communication module may transfer the received signal to the master communication module. Then the master communication module may process the transferred signal.

In accordance with another aspect of the present invention, an apparatus for a communication of a multiple-standby mobile terminal is provided. This apparatus includes a master communication module for determining a communication mode, and a slave communication module for transmitting a wireless signal when the master communication module transfers the signal to be transmitted to the slave communication module. In this apparatus, the master communication module determines whether the communication mode is for the slave communication module. Also, the master communication module transfers the signal to the slave communication module if the communication mode is for the slave communication module, and wirelessly transmits the signal if the communication mode is not for the slave communication module.

In this apparatus, the slave communication module may be further configured to, when a wireless signal is received, transfer the received signal to the master communication module.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile communication terminal in accordance with an exemplary embodiment of the present invention.

FIG. 2 is a block diagram illustrating a configuration of a master control unit in accordance with an exemplary embodiment of the present invention.

FIG. 3 is a block diagram illustrating a configuration of a slave control unit in accordance with an exemplary embodiment of the present invention.

FIG. 4 is a flow diagram illustrating a communication method of a master communication module in a mobile communication terminal in accordance with an exemplary embodiment of the present invention.

FIG. 5 is a flow diagram illustrating an execution method of a direct control mode in accordance with an exemplary embodiment of the present invention.

FIG. 6 is a flow diagram illustrating an execution method of an indirect control mode in accordance with an exemplary embodiment of the present invention.

FIG. 7 is a flow diagram illustrating a communication method of a slave communication module in a mobile communication terminal in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Hereinafter, a mobile communication terminal refers to a multiple-standby mobile terminal that allows access to at least one network selected from among a number of communication networks that support various communication systems such as Code Division Multiple Access (CDMA), Global System for Mobile communication (GSM), Wideband CDMA (WCDMA), Wireless Broadband (WiBro), and the like. Although the following description is based on the assumption that a mobile terminal tries to access one communication network, the present invention is not limited to that case. Namely, this invention may be applied to the mobile terminal that has at least two communication modules. Through these modules, the mobile terminal can allow simultaneous access to a number of communication networks.

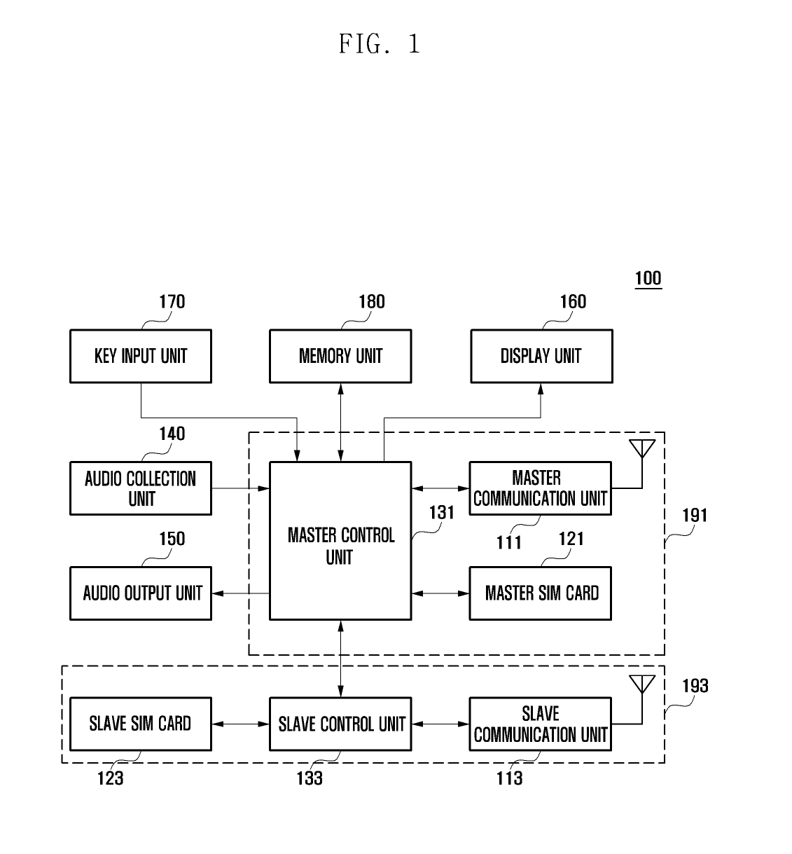

FIG. 1 is a block diagram illustrating a configuration of a mobile communication terminal in accordance with an exemplary embodiment of the present invention. This embodiment is based on the assumption that the mobile communication terminal is a mobile phone. However, it is to be understood that this is merely for sake of convenience and not intended to be limiting.

Referring to FIG. 1, the mobile terminal includes a master communication unit 111, a slave communication unit 113, a master Subscriber Identity Module (SIM) card 121, a slave SIM card 123, a master control unit 131, a slave control unit 133, an audio collection unit 140, an audio output unit 150, a display unit 160, a key input unit 170, and a memory unit 180. More particularly, a master communication module 191 is composed of the master communication unit 111, the master SIM card 121 and the master control unit 131. Similarly, a slave communication module 193 is composed of the slave communication unit 113, the slave SIM card 123 and the slave control unit 133.

The master communication unit 111 and the slave communication unit 113 each performs a wireless communication function of the mobile terminal 100 through at least one communication network. More particularly, the master communication unit 111 and the slave communication unit 113 wirelessly send and receive a signal according to a communication protocol that each communication network supports. Each of the master communication unit 111 and the slave communication unit 113 has a Radio Frequency (RF) transmitter that up-converts the frequency of an outgoing signal and amplifies the signal, an RF receiver that low-noise amplifies an incoming signal and down-converts the frequency of the signal, and the like.

The master SIM card 121 and the slave SIM card 123 support a wireless communication function of the mobile terminal 100. Namely, each of the master SIM card 121 and the slave SIM card 123 supports communications with communication networks. Here, each of the master SIM card 121 and the slave SIM card 123 is a kind of smart card that contains information, such as subscriber information, authentication information, communication-related records, and the like, required for communications with the respective networks. In the master SIM card 121 and the slave SIM card 123, such information is managed according to a file system composed of a Master File (MF), a Dedicated File (DF) and an Elementary File (EF). Each of the master SIM card 121 and the slave SIM card 123 can be connected to or separated from the mobile terminal 100 through a card connector (not shown).

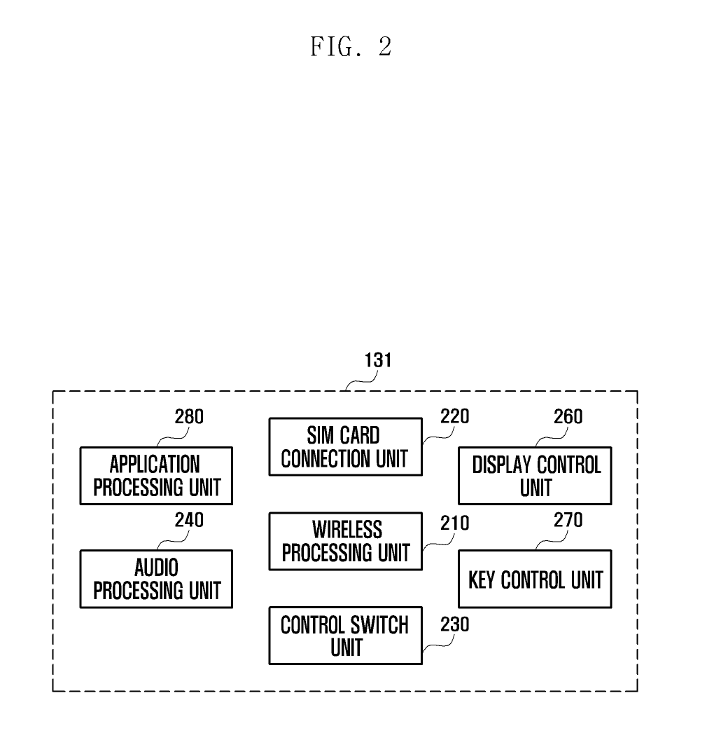

The master control unit 131 performs a function to control operations of the mobile terminal 100. More particularly, the master control unit 131 has a data processing unit, which is composed of a transmitting part that encodes and modulates an outgoing signal, and a receiving part that demodulates and decodes an incoming signal. The data processing unit may be formed of a modulator/demodulator (modem) and a coder/decoder (codec). The codec may have a data codec for processing packet data and an audio codec for processing an audio signal such as voice. Additionally, the master control unit 131 performs a multiple-standby function of the mobile terminal 100. Also, the master control unit 131 may perform a call function by using the master communication unit 111 and the master SIM card 121. A more detailed configuration of the master control unit 131 will be described later with reference to FIG. 2.

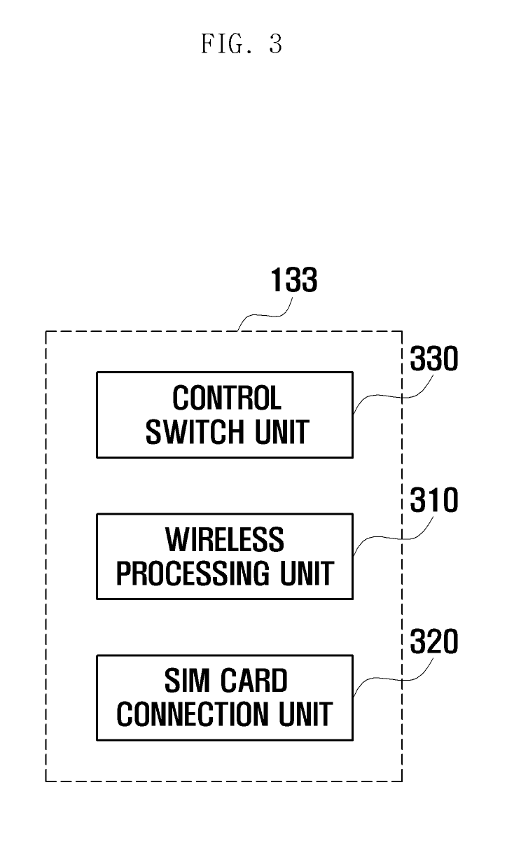

The slave control unit 133 performs a multiple-standby function of the mobile terminal 100. Also, the slave control unit 133 may perform a call function by using the slave communication unit 113 and the slave SIM card 123. A more detailed configuration of the slave control unit 133 will be described later with reference to FIG. 3.

The audio collection unit 140 performs a function to gather an audio signal to be transmitted and to deliver it to the audio codec of the data processing unit. A typical microphone may be used for the audio collection unit 140.

The audio output unit 150 performs a function to receive an audio signal from the audio codec of the data processing unit and to output it. A typical speaker may be used for the audio output unit 150.

The display unit 160 represents user data outputted from the master control unit 131. The display unit 160 may be formed of a Liquid Crystal Display (LCD) and also have an LCD controller, a memory for storing image data, and the like. If the display unit 160 adopts a touch screen type display, it may further act as an input unit of the mobile terminal.

The key input unit 170 is formed of alphanumeric keys for entering letters or numbers into the mobile terminal, and function keys for performing functions of the mobile terminal.

The memory unit 180 may be composed of a program memory and a data memory. The program memory stores programs for controlling the general operation of the mobile terminal 100. More particularly, the program memory stores specific programs for a multiple standby. The data memory stores data created while programs are executed. The memory unit 180 may store shared information required for access to the communication network through the master communication unit 111 and the slave communication unit 113, for example, at least parts of SIM information of the master SIM card 121 and the slave SIM card 123.

FIG. 2 is a block diagram illustrating the configuration of a master control unit in accordance with an exemplary embodiment of the present invention.

Referring to FIG. 2, the master control unit 131 includes a wireless processing unit 210, a SIM card connection unit 220, a control switch unit 230, an audio processing unit 240, a display control unit 260, a key control unit 270, and an application processing unit 280. These elements in the master control unit 131 interact with each other.

The wireless processing unit 210 performs a function to control the master communication unit 111. Interfacing with the master communication unit 111, the wireless processing unit 210 processes a wireless signal received or to be transmitted through the master communication unit 111.

The SIM card connection unit 220 performs a function to control the master SIM card 121. Interfacing with the master SIM card 121, the SIM card connection unit 220 communicates SIM information of the master SIM card 121.

The control switch unit 230 performs a function to control the slave control unit 133. Interfacing with the slave control unit 133, the control switch unit 230 exchanges a wireless signal received or to be transmitted with the slave control unit 133.

The audio processing unit 240 performs a function to control the audio collection unit 140 and the audio output unit 150. Interfacing with each of the audio collection unit 140 and the audio output unit 150, the audio processing unit 240 not only processes an audio signal input from the audio collection unit 140, but also processes an audio signal to be output to the audio output unit 150. The audio processing unit 240 may be formed of a modem and an audio codec.

The display control unit 260 performs a function to control the display unit 160. Interfacing with the display unit 160, the display control unit 260 sends user data to be displayed to the display unit 160.

The key control unit 270 performs a function to control the key input unit 170. Interfacing with the key input unit 170, the key control unit 270 identifies a key signal input from the key input unit 170.

The application processing unit 280 performs a function to control the memory unit 180. Interfacing with the memory unit 180, the application processing unit 280 executes programs in the memory unit 180.

FIG. 3 is a block diagram illustrating a configuration of a slave control unit in accordance with an exemplary embodiment of the present invention.

Referring to FIG. 3, the slave control unit 133 includes a wireless processing unit 310, a SIM card connection unit 320, and a control switch unit 330. These elements in the slave control unit 133 interact with each other.

The wireless processing unit 310 performs a function to control the slave communication unit 113. Interfacing with the slave communication unit 113, the wireless processing unit 310 processes a wireless signal received or to be transmitted through the slave communication unit 113.

The SIM card connection unit 320 performs a function to control the slave SIM card 123. Interfacing with the slave SIM card 123, the SIM card connection unit 320 communicates SIM information of the slave SIM card 123.

The control switch unit 330 performs a function to control the master control unit 131. Interfacing with the master control unit 131, the control switch unit 330 exchanges a wireless signal received or to be transmitted with the master control unit 131.

Namely, the master communication module 191 can perform a communication with the communication network directly or indirectly through the slave communication module 193. Therefore, the master communication module 191 analyzes and processes a signal received or to be transmitted indirectly as well as a signal received or to be transmitted directly. Additionally, the master communication module 191 transmits and receives a wireless signal with the communication network, and also the slave communication module 193 transmits and receives a wireless signal with the communication network. In other words, the slave communication module 193 merely transmits and receives a signal, neither analyzing nor processing the signal. Therefore, the slave communication module 193 needs no elements for analyzing or processing a signal.

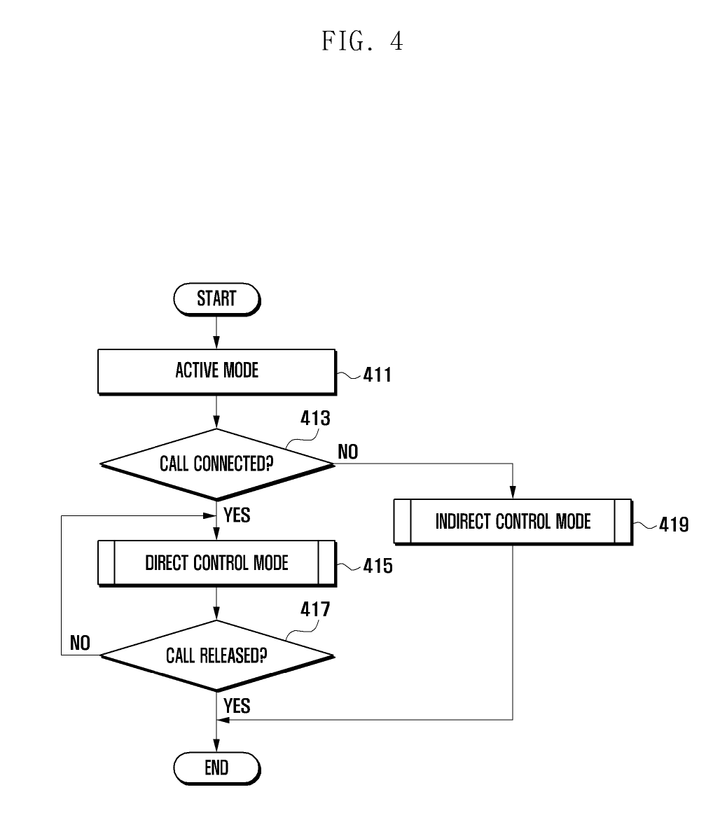

FIG. 4 is a flow diagram illustrating a communication method of a master communication module in a mobile communication terminal in accordance with an exemplary embodiment of the present invention. This embodiment is based on the assumption that the mobile communication terminal performs a voice call. Of course, this is merely for sake of convenience and not intended to be limiting.

Referring to FIG. 4, at the outset, the master control unit 131 of the master communication module 191 is in an active mode in step 411. In this step, the master control unit 131 may be running with full power and operate all elements thereof. In step 413, the master control unit 131 determines if a call is connected through the master communication unit 111. If it is determined in step 413 that a call is connected, the master control unit performs a direct control mode in step 415. The direct control mode is a specific communication mode for the master communication module 191. In the direct control mode, the master control unit 131 performs a communication directly with the communication network and also processes a signal received from or to be transmitted to the communication network. Now, a more detailed process in the direct control mode will be described.

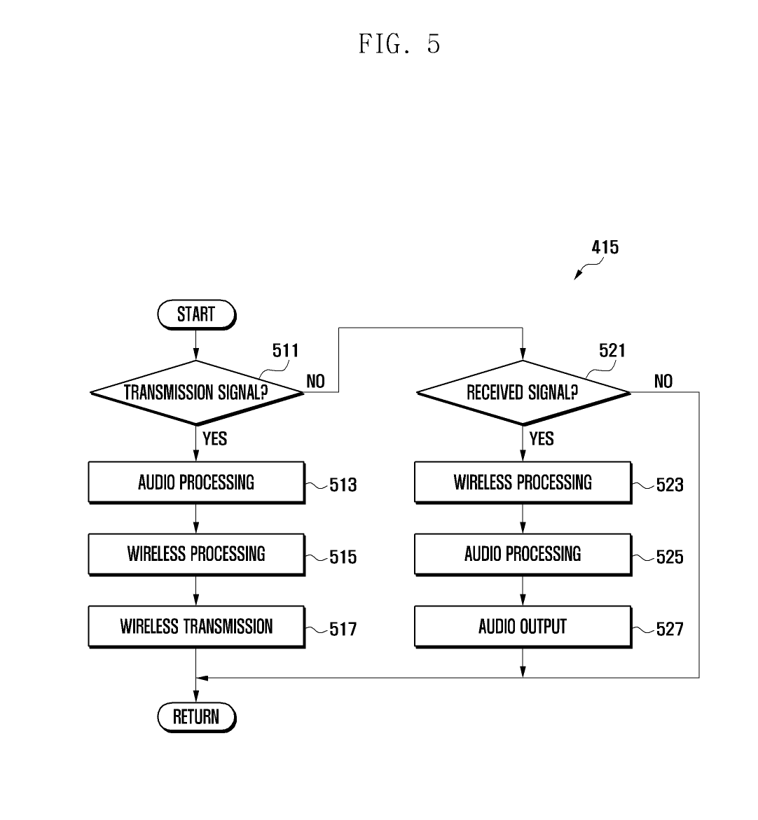

FIG. 5 is a flow diagram illustrating an execution method of a direct control mode in accordance with an exemplary embodiment of the present invention.

Referring to FIG. 5, the master control unit 131 determines in step 511 if a signal for transmission is input. If it is determined in step 511 that a transmission signal is input, the master control unit 131 performs an audio processing of the signal in step 513. More specifically, the audio collection unit 140 may gather the signal and send it to the audio processing unit 240. Then the audio processing unit 240 may encode and modulate the signal and send it to the wireless processing unit 210. Additionally, the master control unit 131 performs a wireless processing of the signal in step 515. More specifically, when the signal is received from the audio processing unit 240, the wireless processing unit 210 may control the master communication unit 111 so that the master communication unit 111 may up-convert the frequency of the signal and also amplify the signal. The master communication unit 111 wirelessly transmits the signal under the control of the master control unit 131 in step 517 and then returns to the process in FIG. 4.

On the other hand, if it is determined in step 511 that a signal for transmission is not input, the master control unit 131 determines in step 521 if a wireless signal is received. If it is determined in step 521 that a wireless signal is received, the master control unit 131 performs a wireless processing of the signal in step 523. More specifically, the master communication unit 111 may receive the signal and send it to the wireless processing unit 210. Then the wireless processing unit 210 may control the master communication unit 111 so that the master communication unit 111 may low-noise amplify the signal and down-convert the frequency of the signal. Additionally, the master control unit 131 performs an audio processing of the signal in step 525. More specifically, when the signal is received from the wireless processing unit 210, the audio processing unit 240 may demodulate and decode the signal. Next, the master control unit 131 outputs the signal in step 527 and then returns to the process in FIG. 4. In this step, the audio processing unit 240 may output the signal through the audio output unit 150.

Returning to FIG. 4, the master control unit 131 determines in step 417 if the call connection is released through the master communication unit 111. If it is determined in step 417 that the call connection is released, the master control unit 131 ends a communication process. Here, the master control unit 131 may maintain the active mode. If the call release is not recognized in the step 417, the master control unit 131 repeatedly performs step 415.

Meanwhile, if it is determined in step 413 that a call is not connected, the master control unit 131 performs an indirect control mode in step 419. The indirect control mode is a specific communication mode for the slave communication module 193. In the indirect control mode, the master control unit 131 performs a communication indirectly with the communication network and also processes a signal received from or to be transmitted to the communication network through the slave communication module 193. Now, a more detailed process in the indirect control mode will be described.

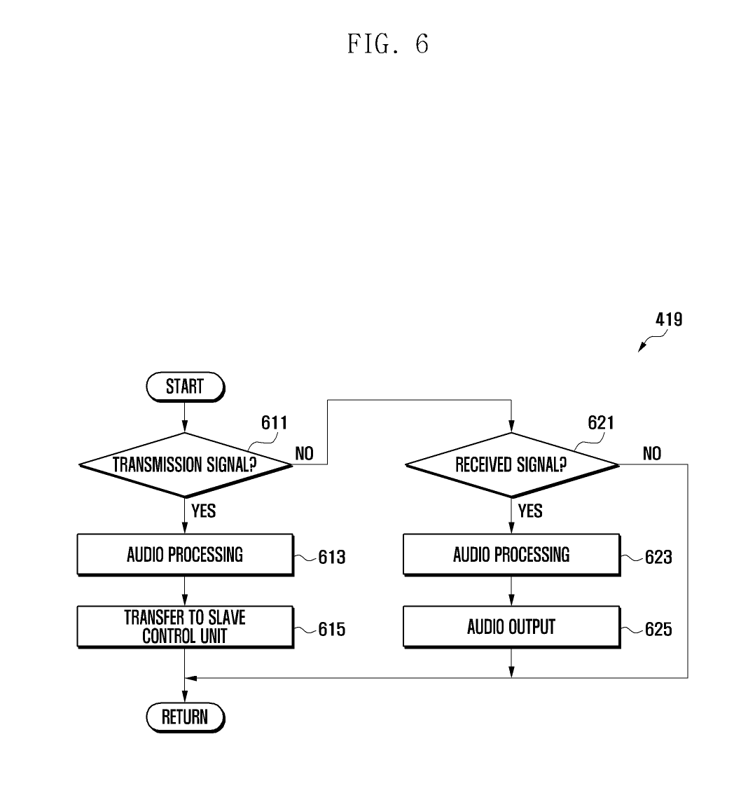

FIG. 6 is a flow diagram illustrating an execution method of an indirect control mode in accordance with an exemplary embodiment of the present invention.

Referring to FIG. 6, the master control unit 131 determines in step 611 if a signal for transmission is input in the indirect control mode. If it is determined in step 611 that the signal for transmission is input, the master control unit 131 performs an audio processing of the signal in step 613. More specifically, the audio collection unit 140 may gather the signal and send it to the audio processing unit 240. Then the audio processing unit 240 may encode and modulate the signal and send it to the control switch unit 230. Additionally, the master control unit 131 transfers the signal to the slave control unit 133 in step 615. More specifically, when the signal is received from the audio processing unit 240, the control switch unit 230 transfers the signal to the slave control unit 133 and then returns to the process in FIG. 4.

On the other hand, if it is determined in step 611 that the signal for transmission is not input, the master control unit 131 determines in step 621 if a wireless-processed signal is received in the indirect control mode. If it is determined in step 621 that a wireless-processed signal is received, the master control unit 131 performs an audio processing of the signal in step 623. More specifically, the control switch unit 230 may receive the wireless-processed signal and transfer it to the audio processing unit 240. Then the audio processing unit 240 may demodulate and decode the signal. Next, the master control unit 131 outputs the signal in step 625 and then returns to the process in FIG. 4. In this step, the audio processing unit 240 may output the signal through the audio output unit 150.

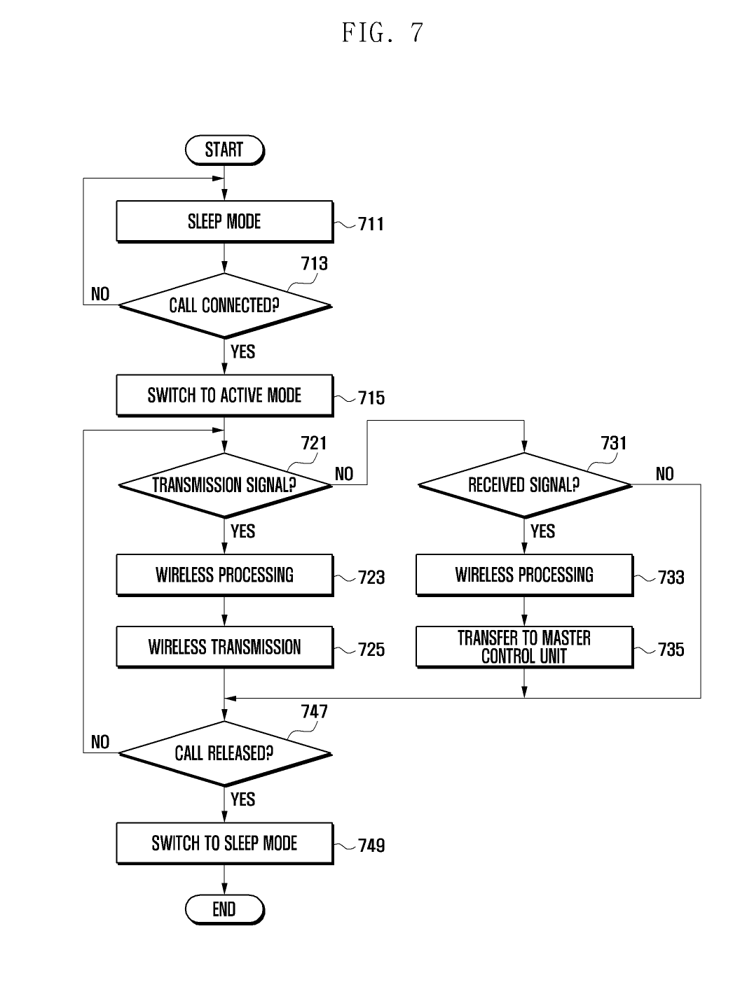

FIG. 7 is a flow diagram illustrating a communication method of a slave communication module in a mobile communication terminal in accordance with an exemplary embodiment of the present invention. This embodiment is based on the assumption that the mobile communication terminal performs a voice call. Of course, this is merely for sake of convenience and not intended to be limiting.

Referring to FIG. 7, at the outset, the slave control unit 133 of the slave communication module 193 is in a sleep mode in step 711. In this step, the slave control unit 133 may be running with the minimum power and operate parts of elements thereof without supplying power to the other elements. In step 713, the slave control unit 133 determines if a call is connected through the slave communication unit 113. If it is determined in step 713 that a call is connected, the slave control unit 133 switches to an active mode in step 715. Therefore, the slave control unit may be running with full power and operate all elements thereof.

In step 721, the slave control unit 133 determines if a signal audio-processed for transmission is input in the active mode. If it is determined in step 721 that a signal audio-processed for transmission is input, the slave control unit 133 performs a wireless processing of the signal in step 723. More specifically, the control switch unit 330 may receive the audio-processed signal from the master control unit 131 and send it to the wireless processing unit 310. Then the wireless processing unit 310 may control the slave communication unit 113 so that the slave communication unit 113 may up-convert the frequency of the signal and also amplify the signal. Next, the slave communication unit 113 transmits the signal wirelessly under the control of the slave control unit 133 in step 725.

On the other hand, if it is determined in step 721 that an audio-processed signal for transmission is not input, the slave control unit 133 determines in step 731 if a wireless signal is received in the active mode. If it is determined in step 731 that a wireless signal is received, the slave control unit 133 performs a wireless processing of the signal in step 733. More specifically, the slave communication unit 113 may receive the signal and send it to the wireless processing unit 310. Then the wireless processing unit 310 may control the slave communication unit 113 so that the slave communication unit 113 may low-noise amplify the signal and also down-convert the frequency of the signal. Additionally, the wireless processing unit 310 may send the signal to the control switch unit 330. Next, the slave control unit 133 transfers the signal to the master control unit 131 in step 735. In this step, the control switch unit 330 transfers the signal to the master control unit 131.

In step 747, slave control unit 133 determines if the call connection is released through the slave communication unit 113. If it is determined in step 747 that the call connection is released, the slave control unit 133 switches to the sleep mode in step 749, and ends a communication process. If the call release is not recognized in step 747 after step 725 or 735, the slave control unit 133 returns to step 721 and repeatedly performs steps 721 to 725 or steps 731 to 735.

Although the above-discussed exemplary embodiment relates to the transfer of a signal between the master and slave communication modules in case of a voice call in the mobile terminal, the present invention is not limited thereto. For instance, this invention may be applied to a packet communication via the network. In this case, the master communication module may save the signal in the memory unit or display on the display unit. Furthermore, the master communication module may send or receive a signal to or from a short range communication device based on Bluetooth, infrared communication, etc. Namely, the master communication module may receive a signal wirelessly or from the slave communication module, processes the signal, and send it to the short range communication device. Also, the master communication module may receive a signal from the short range communication device, processes the signal, and send it wirelessly or to the slave communication module.

In addition, although the above-discussed exemplary embodiment relates to a case where the master and slave communication modules in the mobile terminal make access to the same communication network, the present invention is not limited to that. Alternatively, this invention may be applied to another case where the master and slave communication modules make a separate access to different communication networks. In this case, the slave communication module may include at least one of a modem and a codec. Therefore, the slave communication module may support a signal processing function of the master communication module.

As fully discussed hereinbefore, in an exemplary mobile terminal of this invention, the master communication module directly receives a signal from the communication network and then processes it, or processes a signal to be transmitted and then directly transmits it to the communication network. Additionally, the master communication module indirectly receives a signal from the communication network through the slave communication module and then processes it, or processes a signal to be transmitted and then indirectly transmits it to the communication network through the slave communication module. Namely, the master communication module processes a signal received or to be transmitted through the slave communication module as well as a signal directly received or to be directly transmitted. Therefore, even though the slave communication module has only elements for transmitting and receiving a signal with the other elements eliminated, the multiple-standby mobile terminal may operate favorably. Similarly, the multiple-standby mobile terminal may operate without a typical switching member. Accordingly, the multiple-standby mobile terminal of this invention has advantages of a simpler configuration, a reduced size, and reduced production cost.

While this invention has been shown and described with reference to an exemplary embodiment thereof, it will be understood by those skilled in the art that various changes in form and details may be made therein without departing from the spirit and scope of the invention as defined by the appended claims and their equivalents.

What is claimed is:

1. A method for a communication by a multiple-standby mobile terminal, the method comprising:
determining, by a master communication module, a communication mode;
if the communication mode is for a slave communication module, transferring, by the master communication module, a signal to be transmitted to the slave communication module; and
transmitting, by the slave communication module, the signal wirelessly.

2. The method of claim 1, further comprising:
when a wireless signal is received, transferring, by the slave communication module, the received signal to the master communication module; and
processing, by the master communication module, the transferred signal.

3. The method of claim 1, further comprising:
if the communication mode is for the master communication module, transmitting, by the master communication module, the signal wirelessly.

4. The method of claim 3, further comprising:
when a wireless signal is received, processing, by the master communication module, the received signal.

5. The method of claim 2, wherein the processing of the transferred signal includes outputting the received signal.

6. The method of claim 4, wherein the processing of the received signal includes outputting the received signal.

7. An apparatus for a communication of a multiple-standby mobile terminal, the apparatus comprising:
a master communication module for determining a communication mode; and
a slave communication module for transmitting a signal wirelessly when the master communication module transfers the signal to be transmitted to the slave communication module,
wherein the master communication module determines whether the communication mode is for the slave communication module, and wherein the master communication module transfers the signal to the slave communication module if the communication mode is for the slave communication module, and the master communication module transmits the signal wirelessly if the communication mode is not for the slave communication module.

8. The apparatus of claim 7, wherein the slave communication module is further configured to, when a wireless signal is received, transfer the received signal to the master communication module.

9. The apparatus of claim 8, wherein the master communication module is further configured to process the transferred signal.

10. The apparatus of claim 7, wherein the master communication module is further configured to, when a wireless signal is received, process the received signal.

11. The apparatus of claim 9, wherein the master communication module is further configured to output the transferred signal.

12. The apparatus of claim 10, wherein the master communication module is further configured to output the received signal.
